(19) United States
(12) Patent Application Publication
(10) Pub. No.: US 2026/0200770 A1
(43) Pub. Date: Jul. 16, 2026

(54) SEQUENTIAL REMOVAL OF DIVALENT CATIONS FROM HIGH SALINITY WATER USING MINERALIZATION OF CARBON DIOXIDE

(71) Applicants: ARAMCO SERVICES COMPANY, Houston, TX (US); SAUDI ARABIAN OIL COMPANY, Dhahran (SA)

(72) Inventors: Shiv Shankar SANGARU, Dhahran (SA); Ayrat GIZZATOV, Cambridge, MA (US); Amr I. ABDEL-FATTAH, Dhahran (SA)

(73) Assignees: ARAMCO SERVICES COMPANY, Houston, TX (US); SAUDI ARABIAN OIL COMPANY, Dhahran (SA)

(21) Appl. No.: 19/025,108

(22) Filed: Jan. 16, 2025

(51) Int. Cl. C02F 1/52; C02F 1/00; C02F 1/66; C02F 101/10; C02F 103/06; C02F 103/08

(52) U.S. Cl. CPC C02F 1/52; C02F 1/001; C02F 1/66; C02F 2101/10; C02F 2103/06; C02F 2103/08; C02F 2209/06

(57) ABSTRACT

Carbon dioxide (CO₂) mineralization methods. Methods may comprise: (i) providing a high salinity water comprising at least one monovalent and at least one divalent cation selected from the group consisting of: Mg, Ca, Na, K, and Li cations; (ii) if necessary, increasing the high salinity water pH value, thereby forming a Mg(OH)₂ precipitate if Mg cations are present; (iii) separating any formed Mg(OH)₂ precipitate from a first supernatant comprising monovalent and/or divalent ions selected form the group consisting of: Ca, Na, K, and Li cations; (iv) if necessary, increasing the pH value of the first supernatant to about 12 or greater; (v) introducing CO₂ nanobubbles into the first supernatant, thereby forming a CaCO₃ precipitate if Ca cations are present; and (vi) separating any formed CaCO₃ precipitate from a second supernatant comprising monovalent ions selected from the group consisting of: Na, K, and Li cations.

### FIELD OF THE DISCLOSURE

The present disclosure relates generally to processes for the mineralization of carbon dioxide through treatment of high salinity water and, more particularly, to sequential removal of divalent cations from high salinity water through mineralization of carbon dioxide.

### BACKGROUND

During upstream operations, the oil and gas industry produces large volumes of high salinity waters with high content of divalent and monovalent cations, produced from oil and gas reservoirs during oil and gas operations and/or used in upstream production operations. These waters generally cannot be simply released back into the environment, as the high salinity, potentially hazardous metals, such as barium or strontium, and radionuclides of such waters may negatively affect the soil and vegetation in the disposal area. Thus, these high salinity waters must be carefully treated, transported, and disposed of as wastewater, which can be time-consuming and expensive.

Separately, fossil-fuel consumption in heating/cooling, power generation, transport, and industry has resulted in a rise in carbon dioxide (CO₂) emissions, which is thought to contribute to global warming. Technologies that can offer carbon capture, utilization, and storage of this large quantity of CO₂ are helpful to achieve sustainability targets. Accordingly, technologies which can utilize and store CO₂ while simultaneously treating high salinity fluids would be highly desirable.

### BRIEF SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A nonlimiting example method of the present disclosure may include: (i) providing a high salinity water having a pH value and comprising at least one monovalent cation and at least one divalent cation selected from the group consisting of: Mg, Ca, Na, K, and Li cations; (ii) if the pH value of the high salinity water is less than about 10.5, adjusting said pH value to about 10.5, thereby forming a magnesium hydroxide (Mg(OH)₂) precipitate if Mg cations are present; (iii) if Mg(OH)₂ is formed, performing a filtration of the high salinity water to separate the Mg(OH)₂ precipitate from a first supernatant, the first supernatant having a pH value and comprising monovalent and/or divalent ions selected form the group consisting of: Ca, Na, K, and Li cations; (iv) if the pH value of the first supernatant is less than about 12, adjusting said pH value to about 12 or greater; (v) introducing carbon dioxide (CO₂) nanobubbles into the first supernatant, thereby forming a calcium carbonate (CaCO₃) precipitate if Ca cations are present; and (vi) if CaCO₃ is formed, performing a filtration of the first supernatant to separate the CaCO₃ precipitate from a second supernatant, the second supernatant comprising monovalent ions selected from the group consisting of: Na, K, and Li cations.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 illustrates a schematic of an example of a process for selectively removing divalent cations including Mg and Ca cations from high salinity water via carbon dioxide mineralization according to the present disclosure.

FIG. 2 illustrates a schematic of an example of an additional process for extraction and/or sequestration of remaining monovalent cations including Na, K, Li cations from one or more supernatants formed by the process of FIG. 1.

### DETAILED DESCRIPTION

Embodiments of the present disclosure will now be described in detail with reference to the accompanying Figure. Like elements in the figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figure may vary without departing from the scope of the present disclosure.

The present disclosure relates generally to processes for the mineralization of carbon dioxide through treatment of high salinity water and, more particularly, to sequential removal of divalent cations from high salinity water through mineralization of carbon dioxide. Advantages of the disclosed processes are multifold and likely include generation of increased purity, high-value divalent cation salts, as compared to traditional carbon dioxide mineralization reactions, sustainable utilization and storage of carbon dioxide, as well as remediation of large volumes of high salinity water generated by the oil and gas industry. An additional advantage of the disclosed sequential carbon dioxide mineralization reactions relates to the ability to remediate these large volumes of high salinity water without requiring a preceding process for removing monovalent cations from solution. A further advantage of the disclosed sequential carbon dioxide mineralization reactions relates to the ability to generate aqueous streams which are essentially free of divalent cations, which facilitates the subsequent separation of any remaining monovalent cations for reuse or sequestration thereof.

In view of the structural and functional features described above, example methods and systems may be appreciated with reference to the figures.

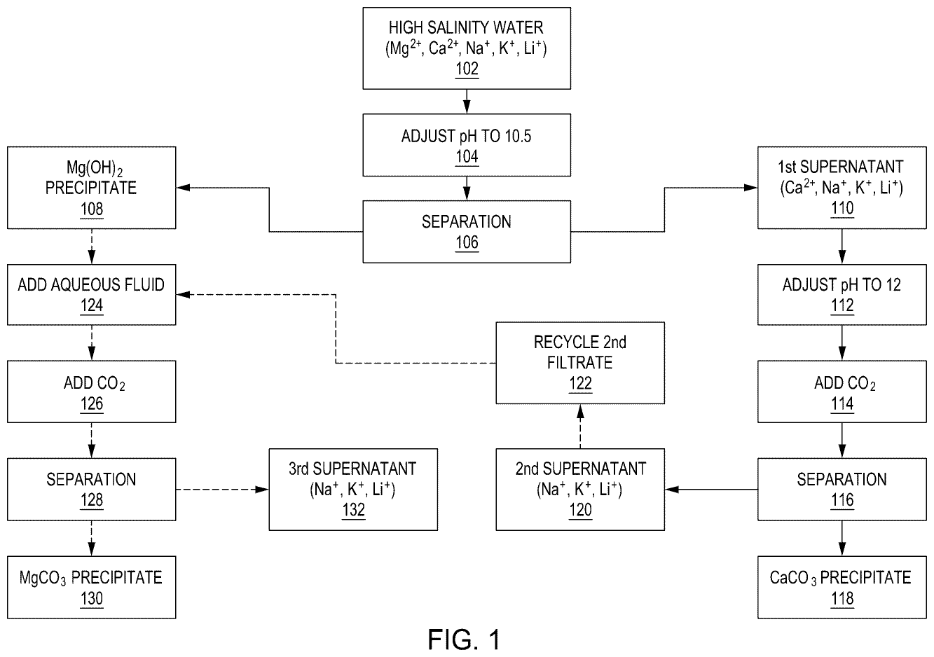

FIG. 1 illustrates an embodiment of the processes disclosed herein for sequentially precipitating divalent cations from a high salinity water as high purity divalent salts using carbon dioxide mineralization, as well as the optional recovery and reuse of any remaining monovalent salts. Methods of the present disclosure may be implemented as shown in FIG. 1. Solid boxes and arrows indicate required steps of the method, while dashed boxes and arrows indicate optional steps of the method. With reference to FIG. 1, shown at 102 is a supply of high salinity water. This high salinity water may be from any suitable source, e.g., an oil and gas operation. The high salinity water may comprise a pH less than about 10.5. The high salinity water stream may comprise various divalent cations and monovalent cations including Mg, Ca, Na, K, and Li cations.

A first series of steps may be used to selectively remove magnesium cations (Mg²⁺) from the high salinity water. As shown at step 104, if necessary, the high salinity water 102 is treated with a pH adjuster to adjust the pH value of the high salinity water to about 10.5. If the pH of the high salinity water 102 is less than about 10.5, the pH adjuster may be an alkaline agent added to the high salinity water 102 to increase the pH value thereof. Alternatively, if the pH of the fluid is above 10.5, a suitable pH adjuster may be an acidic agent capable of lowering the pH to the 10.5 range. At a pH of about 10.5, magnesium cations (Mg²⁺), if present, should selectively precipitate from the high salinity water as magnesium hydroxide (Mg(OH)₂) (shown in FIG. 1 as Mg(OH)₂ precipitate 106). Next, as shown at step 6, a separation process performed on the high salinity water 102 removes the Mg(OH)₂ precipitate 106 from a first supernatant 110, the first supernatant 110 comprising any remaining monovalent and divalent cations such as Ca, Na, K, and Li cations.

A second series of steps may be used to selectively remove calcium cations (Ca²⁺) from the first supernatant 110. As shown at step 112, if necessary, the first supernatant 110 is treated with a pH adjuster to adjust the pH value of the first supernatant 110 to a pH value of about 12 or greater. If the pH value of the first supernatant 110 is less than about 12, the pH adjuster may include an alkaline agent added to the first supernatant 108 to increase the pH value thereof. If the pH value is higher than 12, a pH adjuster may include an acidic agent capable of decreasing the pH value of the first supernatant. Subsequently, as shown at step 114, carbon dioxide (CO₂), for example, in nanobubbles, may be added to the first supernatant 110. As a result, calcium cations (Ca²⁺), if present, should selectively precipitate as calcium carbonate (CaCO₃) precipitate 118. Next, as shown at step 116, a separation process performed on the first supernatant 110 removes the CaCO₃ precipitate 118 from a second supernatant 120, the second supernatant comprising any remaining monovalent cations such as Na, K, and Li cations.

Optionally, a third series of steps may be performed to convert the recovered Mg(OH)₂ precipitate 108 into a magnesium carbonate (MgCO₃) precipitate 118, if desired. As shown at step 124, aqueous fluid is added to the recovered Mg(OH)₂ precipitate 108 to form an aqueous solution thereof. As shown at step 122, a portion of the second supernatant 120 may be recycled to form a portion of or all of the aqueous fluid added to the Mg(OH)₂ precipitate 108 at step 124. Subsequently, at step 126, carbon dioxide (CO₂), for example, in nanobubbles, may be added to the aqueous solution. Using CO₂ nanobubbles provides significant advantages. The large interfacial area, higher internal pressure and consequent higher mass transfer rates due to smaller size of nanobubbles significantly improves the rate of mineralization. Additionally, the negligible rising velocity of nanobubbles compared micro- and macro bubbles also increases the efficiency of CO₂ utilization reducing the losses due to rapid rise of the unreacted bubbles. As a result of CO₂ addition, magnesium cations (Mg²⁺) should precipitate as magnesium carbonate (MgCO₃) precipitate 118. Next, as shown at step 128, a separation process performed on the aqueous solution may separate the MgCO₃ precipitate 130 from a third supernatant comprising any remaining monovalent cations such as Na, K, and Li cations.

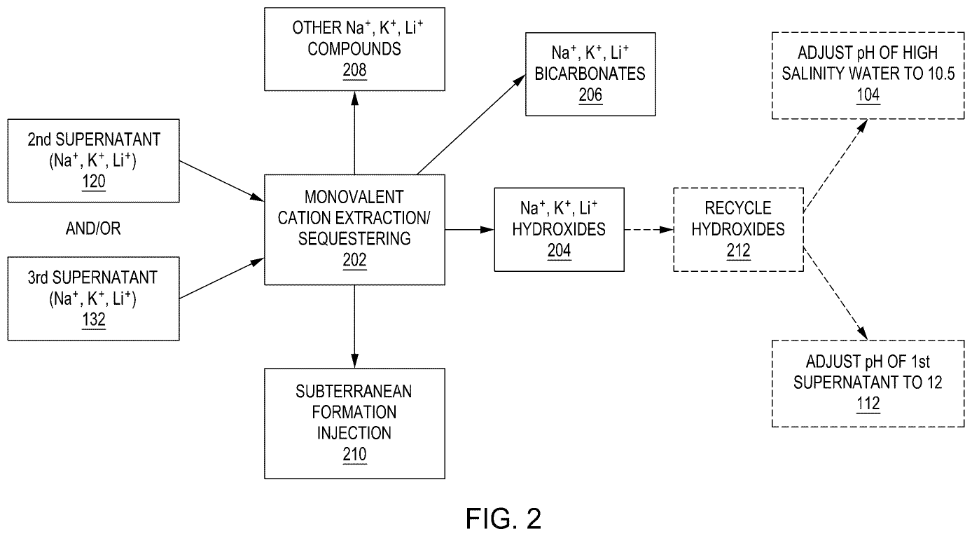

FIG. 2 discloses an additional embodiment that is a potential extension of the embodiment of the process shown in FIG. 1 involving extraction and/or sequestration of any remaining monovalent cations from the second and/or third supernatants, if present. Methods may comprise various additional steps. Solid boxes and arrows indicate required steps of the method, while dashed boxes and arrows indicate optional steps of the method. If the potential extension of FIG. 2 the second supernatant 120 and/or third supernatant 132 from FIG. 1 are further treated at step 202 to produce extract and/or sequester any remaining cations thereof. Extraction methods may produce corresponding hydroxides 204 or bicarbonates 206 or other compounds 208, such as carbonates, chlorides, or the like, of any remaining Na⁺, K⁺, or Li⁺ cations. Further, as shown at step 210, sequestration methods may comprise injecting the second supernatant 120 and/or the third supernatant 132 from FIG. 1, or any aqueous streams from any extraction processes used to produce hydroxides 204, bicarbonates 206, or other compounds 208, of FIG. 2 into a subterranean formation. Optionally, as shown at step 212, at least a portion of the hydroxides 204 may be recycled for use as a portion of or all of the pH adjuster used in FIG. 1 to adjust the pH at steps 104 and/or 112.

While, for purposes of simplicity of explanation, the illustrative methods of FIG. 1 and FIG. 2 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

As shown in FIG. 1, the methods of the present disclosure begin with treatment of a high salinity water 102. The term “high salinity water,” and grammatical variations thereof, as used herein, generally refer to a water with a salinity level greater than that of fresh water. The term “salinity,” and grammatical variations thereof, as used herein, generally refer to the total dissolved solids (TDS) in the water measured for example by electrical conductivity (EC). The term “total dissolved solids (TDS),” and grammatical variations thereof, as used herein, generally refer to the total amount of inorganic salts and organic matter dissolved in water.

Suitable high salinity water may comprise a salinity level of about 0.05% by weight (about 500 ppm) or greater. In various embodiments, the high salinity water may comprise brackish water (i.e., a water having a salinity level of about 0.05% by weight to about 3% by weight (i.e., about 500 ppm to about 30,000 ppm)), saline water (i.e., a water having a salinity level of about 3% by weight to about 5% by weight (i.e., about 30,000 ppm to about 50,000 ppm), brine (i.e., a water having a salinity level of greater than about 5% by weight (i.e., greater than about 50,000 ppm), the like, or any combination thereof. In various embodiments, a high salinity water may comprise a seawater, a groundwater, a subterranean formation water, an oil and gas industry production water, waters associated with a fracturing or other stimulation operation, a wastewater (e.g., a reject water), a synthetic high salinity water thereof, the like, or any combination thereof.

In various embodiments, a suitable high salinity water may comprise a brine, such as a seawater brine, a groundwater brine, a production water brine, a wastewater brine (e.g., a reject water), a synthetic brine thereof, the like, or any combination thereof. A brine may be a water naturally having a sufficient salinity or may be concentrated from a lower salinity water, e.g., a wastewater brine may comprise a higher salinity waste stream generated from a desalination process, a reverse osmosis process, or the like. As used herein, the terms “production water”, “subterranean formation water,” and grammatical variants thereof, refer to water trapped within a “subterranean formation”, i.e., a rock beneath a surface of the Earth, whether a land surface or subsea surface, from which crude oil or other hydrocarbons, e.g., gas, can be produced (i.e., brought to the surface). The rock may comprise, for example, shale, sandstone-based rock, carbonate-based rock, and the like. Production water is thus water brought to the surface along with the produced oil and gas.

Suitable brines may have a salinity level (e.g., a total dissolved solids) of from about 50,000 parts per million (ppm) to about 100,000 ppm, or from about 50,000 ppm to about 90,000 ppm, or from about 50,000 ppm to about 80,000 ppm, or from about 50,000 ppm to about 70,000 ppm, or from about 50,000 ppm to about 60,000 ppm.

Suitable brines may comprise various inorganic salts and ions thereof. Cations present in a brine may comprise at least one cation selected from the group consisting of alkaline earth metal cations (e.g., magnesium cations (Mg²⁺), calcium cations (Ca²⁺), strontium cations (Sr²⁺)), alkali metal cations (e.g., sodium cations (Na⁺), potassium cations (K⁺), and lithium cations (Li⁺)), the like, and any combination thereof. Magnesium cations (Mg²⁺), calcium cations (Ca²⁺), sodium cations (Na⁺), and potassium cations (K⁺) may be the majority of the cations present in a brine. A brine may comprise a molar ratio of magnesium ions to calcium ions of from about 2/1 to about 4/1. A brine may be a lithium rich brine, e.g., a lithium rich groundwater brine, or the like, comprising at least 25 ppm lithium cations (Li⁺), or from about 25 ppm to about 7000 ppm of Li⁺. A brine may comprise at least about 1000 ppm, or at least about 2000 ppm, or at least about 3000 ppm, or from about 1000 ppm to about 3000 ppm, or from about 2000 ppm to about 3000 ppm of total divalent cations. A brine may comprise at least about 15,000 ppm, or at least about 16,000 ppm, or at least 17,000, or at least 18,000, or at least 19,000 ppm, or at least about 20,000 ppm, or from about 17,000 ppm to about 20,000 ppm, or from about 18,000 ppm to about 19,000 ppm, of total monovalent cations.

Suitable brines may comprise various types and/or levels of divalent and monovalent anions. Anions present in a brine may comprise at least one anion selected from the group consisting of halide anions (e.g., chloride anions (Cl⁻), bromide anions (Br⁻), and fluoride anions (F⁻)), sulfate anions (SO₄²⁻), bicarbonate anions (HCO₃⁻), the like, and any combination thereof. Chloride anions (Cl⁻) and sulfate anions (SO₄²⁻) may comprise the majority of the anions present in a brine. A brine may comprise at least 3000 ppm, or at least 4000 ppm, or at least 5000 ppm, or at least 6000 ppm, or at least 7000 ppm, or from about 4000 ppm to about 7000 ppm, or from about 4000 ppm to about 6000 ppm, of total divalent anions. A brine may comprise at least 25,000 ppm, or at least 30,000 ppm, or at least 40,000 ppm, or from about 25,000 ppm to about 40,000 ppm, or from about 30,000 ppm to about 35,000 ppm, of total monovalent anions.

As shown in FIG. 1, the methods of the present disclosure add carbon dioxide (CO₂), optionally CO₂ nanobubbles, to the first supernatant 110 at step 114, and to the aqueous solution of Mg(OH)₂ precipitate 108 at step 126. The terms “CO₂,” and grammatical variations thereof, as used herein, generally refer to gaseous CO₂, aqueous CO₂, the like, or any combination thereof. In various embodiments, the term “gaseous CO₂,” “CO₂ gas”, and grammatical variations thereof, as used herein, generally refer to a gas comprising or consisting of CO₂. The term “aqueous CO₂,” and grammatical variations thereof, as used herein generally refer to an aqueous fluid comprising dissolved and/or dispersed CO₂. The term “CO₂ nanobubbles,” and grammatical variations thereof, as used herein, generally refer to nanometer-sized cavities dispersed within a liquid (e.g., an aqueous fluid) and containing a gas comprising or consisting of gaseous CO₂. CO₂ nanobubbles may be generated prior to introduction and/or in situ (i.e., during introduction). CO₂ nanobubbles may be generated by a porous membrane method, an electrostriction method, a compression-decompression method, an ultrasonic cavitation method, a microfluidic method, or the like. In various embodiments, CO₂ nanobubbles may be from about 0.1 nanometer (nm) to less than about 1,000 nanometers (nm) in diameter, such as, from about 0.1 nm to about 100 nm, or from about 0.1 nm to about 10 nm.

As shown in FIG. 1, the pH value may be increased by adding any suitable alkaline agent, for example to increase the pH value of the high salinity water 102 to about 10.5 at step 104 and/or to increase the pH of the first supernatant 110 to about 12 at step 112. The amount of alkali will depend on the concentration of divalent ions such as magnesium and calcium ions. Higher concentrations of divalent ions will require higher alkali to convert them into their hydroxide forms. Such as converting magnesium ions to magnesium hydroxide. Suitable alkaline agents may include, but are not limited to, ammonia, amines, alkali metal hydroxides, such as sodium hydroxide, potassium hydroxide, and the like. Alkaline agents may exclude alkaline earth metals, carbonate anions, sulfate anions, the like, and any combination thereof. Methods may increase the pH value in step (i), step (iii), or both, by adding an alkali metal hydroxide.

As shown in FIG. 1, methods of the present disclosure may recover various divalent cation precipitates by various separation techniques. Divalent cation precipitates may be recovered from the remaining supernatant by filtration, decanting, centrifugation, or the like. Divalent cation precipitates may have various cationic purity values. Precipitated Mg(OH)₂ precipitate 108 separated at step 106 may have a cationic purity of 29 weight percent (wt %) to 41.6 wt %, based on the total weight of cations in the Mg(OH)₂ precipitate 108, as determined by inductively coupled plasma-optical emission spectroscopy (ICP-OES). Precipitated CaCO₃ 118 separated at step 116 may have a cationic purity of 28 wt % to 40 wt %, based on the total weight of cations in the CaCO₃ precipitate 118, as determined by ICP-OES. Precipitated MgCO₃ 130 separated at step 128 may have a cationic purity of 20 wt % to 28.8 wt %, based on the total weight of cations in the MgCO₃ precipitate 130, as determined by ICP-OES.

After removal of divalent cation precipitates, remaining supernatants may have various residual divalent cation content values at various steps of the methods shown, e.g., in FIG. 1. After separation at step 106, the first supernatant 110 may have a residual Mg cation content of less than 250 ppm or 0.025 weight percent (wt %), based on the total weight of first supernatant 110, as determined by ICP-OES. After separation at step 116, the second supernatant 120 may have a residual Ca cation content of less than 250 ppm or 0.025 weight percent (wt %), based on the total weight of the second supernatant 120, as determined by ICP-OES. After separation at step 128, the third supernatant may have a residual total Mg cation plus Ca cation content of less than 500 ppm or 0.05 weight percent (wt %), based on the total weight of third supernatant 132, as determined by ICP-OES.

Various process temperatures may be used in methods of the present disclosure. Preferred temperatures may include a temperature of about ambient temperature to about 90° C., such as about 20° C. to about 90° C.

Various process pressures may be used in methods of the present disclosure. Preferred pressures may include a pressure of about ambient or about 14.7 pounds per square inch gauge (psig) to about 150 psig, such as about 20 psig to about 120 psig.

The nanobubbles can be generated by equipment based on nano-porous membranes, hydrodynamic cavitation, ultrasonic cavitation, or the like

Table 1 shows the composition of an exemplary brine, e.g., seawater, suitable for use in methods of the present disclosure. Table 2 provides a prophetic estimate for the quantity of various carbonate salts which would be produced from 100,000 barrels (“bbl”, i.e., 1.59×10⁷ liters) of the exemplary brine of Table 1, as well as how much carbon dioxide (CO₂) would be utilized for such conversion, according to the methodology described in the present disclosure, for example, as shown in FIGS. 1 and 2.

TABLE 1

| Cations | Concentration (mg/L) | Anions | Concentration (mg/L) |
|---|---|---|---|
| Ca²⁺ | 680 | Cl⁻ | 30,781 |
| Mg²⁺ | 2190 | SO₄²⁻ | 5,960 |
| Na⁺ | 18,000 | HCO₃⁻ | 127 |
| K⁺ | 618 | | |
| Sr²⁺ | 14 | | |

TABLE 2

| Mineralized | Mineralized salt formed (kg) | CO₂ consumed (kg) |
|---|---|---|
| salt | per 100,000 bbl seawater | per 100,000 bbl seawater |
| CaCO₃ | 27,000 | 11,872 |
| MgCO₃ | 120,784 | 63,047 |
| NaHCO₃ | 747,000 | 547,837 |
| KHCO₃ | 21,111 | 11,060 |

### Example Embodiments

The present disclosure is directed to the following non-limiting embodiments.

Embodiment 1. A method comprising: (i) providing a high salinity water having a pH value and comprising at least one monovalent cation and at least one divalent cation selected from the group consisting of: Mg, Ca, Na, K, and Li cations; (ii) if the pH value of the high salinity water is less than about 10.5, adjusting said pH value to about 10.5, thereby forming a magnesium hydroxide (Mg(OH)₂) precipitate if Mg cations are present; (iii) if Mg(OH)₂ is formed, performing a filtration of the high salinity water to separate the Mg(OH)₂ precipitate from a first supernatant, the first supernatant having a pH value and comprising monovalent and/or divalent ions selected form the group consisting of: Ca, Na, K, and Li cations; (iv) if the pH value of the first supernatant is less than about 12, adjusting said pH value to about 12 or greater; (v) introducing carbon dioxide (CO₂) nanobubbles into the first supernatant, thereby forming a calcium carbonate (CaCO₃) precipitate if Ca cations are present; and (vi) if CaCO₃ is formed, performing a filtration of the first supernatant to separate the CaCO₃ precipitate from a second supernatant, the second supernatant comprising monovalent ions selected from the group consisting of: Na, K, and Li cations.

Embodiment 2. The method of Embodiment 1, wherein the second supernatant has a divalent cation content of less than 0.05 weight percent (wt %) to 15 wt %, based on the total weight of second supernatant, as determined by chemical titration or inductive couple plasma emission spectroscopy (ICP).

Embodiment 3. The method of Embodiment 1 or Embodiment 2, further comprising: (vii) if the Mg(OH)₂ precipitate is formed, mixing the Mg(OH)₂ precipitate with an aqueous fluid to form an aqueous solution thereof; and (viii) introducing CO₂ nanobubbles into the aqueous solution, thereby forming a magnesium carbonate (MgCO₃) precipitate; and (ix) performing a filtration of the aqueous solution to separate the MgCO₃ precipitate from a third supernatant, the third supernatant comprising monovalent cations selected from the group consisting of Na, K, and Li cations.

Embodiment 4. The method of Embodiment 3, wherein the aqueous fluid comprises at least a portion of the second supernatant.

Embodiment 5. The method of Embodiment 3 or Embodiment 4, wherein the third supernatant has a divalent cation content of less than 0.02 weight percent (wt %), based on the total weight of third supernatant, as determined by chemical titration or inductive couple plasma emission spectroscopy (ICP).

Embodiment 6. The method of any one of Embodiments 1 to 5, further comprising: (x) extracting and/or sequestering at least a portion of any monovalent cations present in second supernatant.

Embodiment 7. The method of any one of Embodiments 3 to 6, further comprising: (xi) extracting and/or sequestering at least a portion of any monovalent cations present in the third supernatant.

Embodiment 8. The method of Embodiment 6 or Embodiment 7, wherein extracting comprises hydroxide production, bicarbonate production, carbonate production, chloride production, or any combination thereof.

Embodiment 9. The method of Embodiment 8, wherein extracting comprises hydroxide production, and wherein the method further comprises: (xii) recycling the produced hydroxides to increase the pH value in step (ii) and/or step (iv) in one or more subsequent method cycles.

Embodiment 10. The method of Embodiment 8 or Embodiment 9, wherein extracting comprises lithium chloride production.

Embodiment 11. The method of any one of Embodiments 6 to 10, wherein sequestering comprises injection of any monovalent cations into a subterranean formation.

Embodiment 12. The method of any one of Embodiments 1-11, wherein the high salinity water comprises at least one brine selected from the group consisting of a seawater brine, a groundwater brine, a production water brine, a wastewater brine, a synthetic brine thereof, and any combination thereof.

Embodiment 13. The method of any one of Embodiment 1-12, wherein the high salinity water comprises from about 25 parts per million (ppm) to about 7,000 ppm of lithium cations.

Embodiment 14. The method of any one of Embodiments 1 to 13, wherein Mg and Ca cations comprise a majority of the at least one divalent cation of the high salinity water.

Embodiment 15. The method of any one of Embodiments 1 to 14, wherein the precipitated MgCO₃ has a cationic purity of 60 weight percent (wt %) to 100 wt %, based on the total weight of cations in the precipitated MgCO₃, as determined by chemical titration, x-ray fluorescence spectroscopy (XRF) or inductive couple plasma emission spectroscopy (ICP).

Embodiment 16. The method of any one of Embodiments 1 to 15, wherein the precipitated CaCO₃ has a cationic purity of 60 weight percent (wt %) to 100 wt %, based on the total weight of cations in the precipitated CaCO₃, as determined by chemical titration, x-ray fluorescence spectroscopy (XRF) or inductive couple plasma emission spectroscopy (ICP).

Embodiment 17. The method of any one of Embodiments 1 to 16, wherein introducing the CO₂ nanobubbles comprises forming CO₂ nanobubbles in situ.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is not intended that the invention be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
(i) providing a high salinity water having a pH value and comprising at least one monovalent cation and at least one divalent cation selected from the group consisting of: Mg, Ca, Na, K, and Li cations;
(ii) if the pH value of the high salinity water is less than about 10.5, adjusting said pH value to about 10.5, thereby forming a magnesium hydroxide (Mg(OH)₂) precipitate if Mg cations are present;
(iii) if Mg(OH)₂ is formed, performing a filtration of the high salinity water to separate the Mg(OH)₂ precipitate from a first supernatant, the first supernatant having a pH value and comprising monovalent and/or divalent ions selected form the group consisting of: Ca, Na, K, and Li cations;
(iv) if the pH value of the first supernatant is less than about 12, adjusting said pH value to about 12 or greater;
(v) introducing carbon dioxide (CO₂) nanobubbles into the first supernatant, thereby forming a calcium carbonate (CaCO₃) precipitate if Ca cations are present; and
(vi) if CaCO₃ is formed, performing a filtration of the first supernatant to separate the CaCO₃ precipitate from a second supernatant, the second supernatant comprising monovalent ions selected from the group consisting of: Na, K, and Li cations.

2. The method of claim 1, wherein the second supernatant has a divalent cation content of less than 0.05 weight percent (wt %) to 15 wt %, based on the total weight of second supernatant, as determined by chemical titration or inductive couple plasma emission spectroscopy (ICP).

3. The method of claim 1, further comprising:
(vii) if the Mg(OH)₂ precipitate is formed, mixing the Mg(OH)₂ precipitate with an aqueous fluid to form an aqueous solution thereof; and
(viii) introducing CO₂ nanobubbles into the aqueous solution, thereby forming a magnesium carbonate (MgCO₃) precipitate; and
(ix) performing a filtration of the aqueous solution to separate the MgCO₃ precipitate from a third supernatant, the third supernatant comprising monovalent cations selected from the group consisting of Na, K, and Li cations.

4. The method of claim 3, wherein the aqueous fluid comprises at least a portion of the second supernatant.

5. The method of claim 3, wherein the third supernatant has a divalent cation content of less than 0.02 weight percent (wt %), based on the total weight of third supernatant, as determined by chemical titration or inductive couple plasma emission spectroscopy (ICP).

6. The method of claim 1, further comprising:
(x) extracting and/or sequestering at least a portion of any monovalent cations present in second supernatant.

7. The method of claim 3, further comprising:
(xi) extracting and/or sequestering at least a portion of any monovalent cations present in the third supernatant.

8. The method of claim 6, wherein extracting comprises hydroxide production, bicarbonate production, carbonate production, chloride production, or any combination thereof.

9. The method of claim 8, wherein extracting comprises hydroxide production, and wherein the method further comprises:
(xii) recycling the produced hydroxides to increase the pH value in step (ii) and/or step (iv) in one or more subsequent method cycles.

10. The method of claim 8, wherein extracting comprises lithium chloride production.

11. The method of claim 6, wherein sequestering comprises injection of any monovalent cations into a subterranean formation.

12. The method of claim 1, wherein the high salinity water comprises at least one brine selected from the group consisting of a seawater brine, a groundwater brine, a production water brine, a wastewater brine, a synthetic brine thereof, and any combination thereof.

13. The method of claim 1, wherein the high salinity water comprises from about 25 parts per million (ppm) to about 7,000 ppm of lithium cations.

14. The method of claim 1, wherein Mg and Ca cations comprise a majority of the at least one divalent cation of the high salinity water.

15. The method of claim 1, wherein the precipitated MgCO₃ has a cationic purity of 60 weight percent (wt %) to 100 wt %, based on the total weight of cations in the precipitated MgCO₃, as determined by chemical titration, x-ray fluorescence spectroscopy (XRF) or inductive couple plasma emission spectroscopy (ICP).

16. The method of claim 1, wherein the precipitated CaCO₃ has a cationic purity of 60 weight percent (wt %) to 100 wt %, based on the total weight of cations in the precipitated CaCO₃, as determined by chemical titration, x-ray fluorescence spectroscopy (XRF) or inductive couple plasma emission spectroscopy (ICP).

17. The method of claim 1, wherein introducing the CO₂ nanobubbles comprises forming CO₂ nanobubbles in situ.
